(19) United States
(12) Patent Application Publication
(10) Pub. No.: US 2024/0395136 A1
(43) Pub. Date: Nov. 28, 2024

(54) TRAFFIC MONITORING DEVICE, TRAFFIC MONITORING SYSTEM, TRAFFIC MONITORING METHOD, AND RECORDING MEDIUM

(71) Applicant: NEC Corporation, Minato-ku, Tokyo (JP)

(72) Inventor: Keisuke UTSUMI, Tokyo (JP)

(73) Assignee: NEC Corporation, Minato-ku, Tokyo (JP)

(21) Appl. No.: 18/273,913

(22) PCT Filed: Feb. 14, 2022
(86) PCT No.: PCT/JP2022/005591

§ 371 Date: Jul. 24, 2023

(30) Foreign Application Priority Data
Mar. 30, 2021 (JP) 2021-056368

(51) Int. Cl. G08G 1/095; G08G 1/052

(52) U.S. Cl. CPC G08G 1/095; G08G 1/052

(57) ABSTRACT

The present invention smooths traffic flow by controlling a traffic light appropriately. An acquisition unit (11) acquires time-series image data showing a vehicle, a measurement unit (12) measures the speed of the vehicle by using the time-series image data, and a control unit (13) controls a traffic light facing the vehicle such that the traffic light shows a color indicating permission to go forward when the speed of the vehicle falls within a defined range.

### TECHNICAL FIELD

The present invention relates to a traffic monitoring device, a traffic monitoring system, a traffic monitoring method, and a recording medium, and particularly relates to a traffic monitoring device, a traffic monitoring method, and a recording medium that monitor traffic in the vicinity of an intersection and control passage of vehicles and the like.

### BACKGROUND ART

In an intersection of roads with a low traffic volume, such as a bypass and a back road, one is required to temporarily stop the vehicle due to a red light although the vehicle is not passing along a road that the other vehicles are crossing at all. This causes various problems such as an increase in driving time, deterioration of fuel efficiency, and load of the engine due to restart. Related techniques have been developed to make traffic smoother while ensuring safety at intersections.

In one example, in a related technique described in PTL 1, a sensor is installed on a community road side at an intersection where a highway and the community road intersect. When the sensor senses that a vehicle traveling on the community road approaches the intersection, the traffic light facing the vehicle is turned into a green light by controlling the light color of the traffic light.

In a related technique described in PTL 2, position data and speed data of a vehicle are transmitted to a traffic light in real time by a mobile communication device mounted on the vehicle. Based on the position data and the speed data of the vehicle, it is predicted that the vehicle is approaching the intersection, and the traffic light facing the vehicle is turned into a green light. As a result, the vehicle can pass through the intersection without stopping.

### CITATION LIST

### Patent Literature

PTL 1: JP 2019-159458 A
PTL 2: JP 2012-108664 A

### SUMMARY OF INVENTION

### Technical Problem

In the related technique described in PTL 2, in a case where a vehicle equipped with a mobile communication device and a vehicle equipped with no mobile communication device are mixed, traffic may be disrupted. In addition, since data is transmitted from the vehicle to the traffic light, the traffic light also needs to be equipped with a mobile communication receiver.

The present invention has been made in view of the above problems, and an object of the present invention is to make traffic smoother by appropriately controlling traffic lights.

### Solution to Problem

A traffic monitoring device according to an aspect of the present invention includes an acquisition means that acquires time-series image data showing a vehicle, a measurement means that measures speed of the vehicle using the time-series image data, and a control means that sets a traffic light facing the vehicle to a light color indicating permission to go forward in a case where the speed of the vehicle is within a prescribed range.

A traffic monitoring method according to an aspect of the present invention includes acquiring time-series image data showing a vehicle, measuring speed of the vehicle using the time-series image data, and setting a traffic light facing the vehicle to a light color indicating permission to go forward in a case where the speed of the vehicle is within a prescribed range.

A recording medium according to an aspect of the present invention stores a program that causes a computer to execute acquiring time-series image data showing a vehicle, measuring speed of the vehicle using the time-series image data, and setting a traffic light facing the vehicle to a light color indicating permission to go forward in a case where the speed of the vehicle is within a prescribed range.

A traffic monitoring system according to an aspect of the present invention includes the traffic monitoring device, a camera that images the vehicle, and a traffic light controlled by the traffic monitoring device.

### Advantageous Effects of Invention

According to an aspect of the present invention, traffic can be made smoother by appropriately controlling traffic lights.

### BRIEF DESCRIPTION OF DRAWINGS

FIG. 1 is a diagram schematically illustrating an example of a configuration of a traffic monitoring system to which a traffic monitoring device according to first to third example embodiments is applicable.

FIG. 2 is a block diagram illustrating a configuration of the traffic monitoring device according to the first and second example embodiments.

FIG. 3 is a flowchart illustrating an operation of the traffic monitoring device according to the first example embodiment.

FIG. 4 is a diagram illustrating a flow of control of traffic lights executed by the traffic monitoring device according to the first example embodiment.

FIG. 5 is a flowchart illustrating a modification example of the operation of the traffic monitoring device according to the first example embodiment.

FIG. 6 is a flowchart illustrating an operation of the traffic monitoring device according to the second example embodiment.

FIG. 7 is a diagram illustrating a flow of control of traffic lights executed by the traffic monitoring device according to the second example embodiment.

FIG. 8 is a block diagram illustrating a configuration of the traffic monitoring device according to the third example embodiment.

FIG. 9 is a flowchart illustrating an operation of the traffic monitoring device according to the third example embodiment.

FIG. 10 is a flowchart illustrating a modification example of the operation of the traffic monitoring device according to the third example embodiment.

FIG. 11 is a diagram illustrating an example of a hardware configuration of the traffic monitoring device according to the first to third example embodiments.

### EXAMPLE EMBODIMENT

Hereinbelow, example embodiments of the present invention will be described with reference to the drawings.

### (Traffic Monitoring System 1)

A traffic monitoring system 1 to which any one of traffic monitoring devices 10, 20, and 30 according to first to third example embodiments to be described below is applied will be described. Hereinbelow, “any one of the traffic monitoring devices 10, 20, and 30” is referred to as “the traffic monitoring device 10 (20 or 30)”.

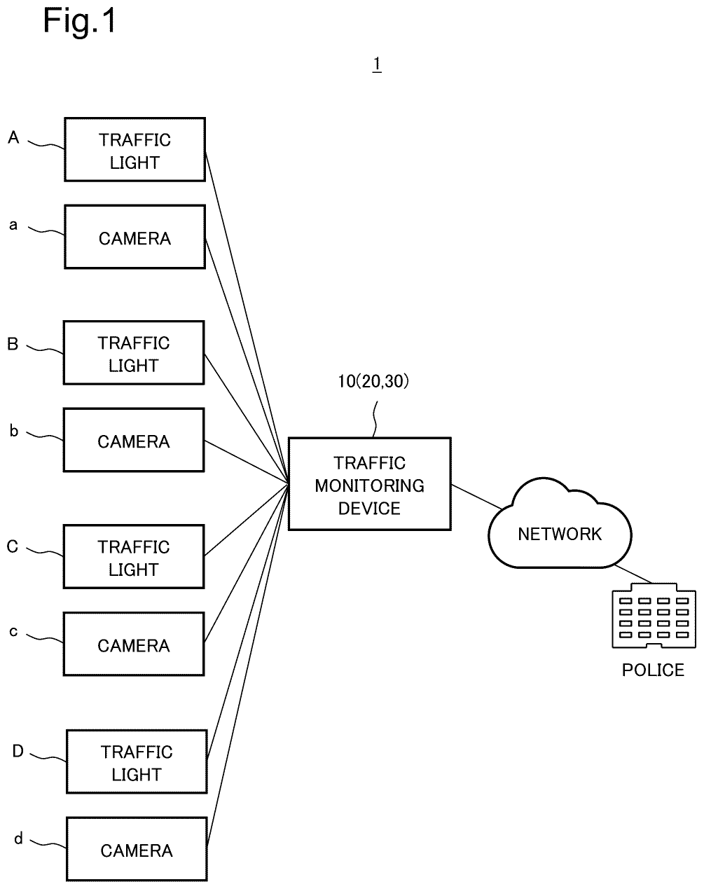

FIG. 1 is a diagram schematically illustrating an example of a configuration of the traffic monitoring system 1. As illustrated in FIG. 1, the traffic monitoring system 1 includes the traffic monitoring device 10 (20 or 30), traffic lights A to D, and cameras a to d. The traffic monitoring device 10 (20 or 30) is connected to a system managed by the police via a wireless or wired network. Hereinbelow, when simply referred to as “police”, it indicates a “system managed by the police”.

The traffic lights A to D are installed in the vicinity of an intersection in such a way as to face vehicles traveling from different directions toward the intersection along roads connected to the intersection. The cameras a to d are paired with the traffic lights A to D.

The cameras a to d are installed in directions to face the traffic lights A to D. The cameras a to d image the vicinity of the intersection of the roads connected to the intersection. In a case where there is a plurality of lanes on each road, the cameras a to d are installed in such a way as to be capable of imaging at least the lanes for vehicles traveling toward the intersection. The cameras a to d transmit time-series image data obtained by imaging to the traffic monitoring device 10 (20 or 30).

The traffic monitoring device 10 (20 or 30) is communicably connected to the traffic lights A to D and the cameras a to d. The traffic monitoring device 10 (20 or 30) controls the traffic lights A to D and the cameras a to d by transmitting control signals to the traffic lights A to D and the cameras a to d.

Specifically, the traffic monitoring device 10 (20 or 30) independently switches the light color of each of the traffic lights A to D. Also, the traffic monitoring device 10 (20 or 30) acquires time-series image data from each of the cameras a to d. In addition, the traffic monitoring device 10 (20 or 30) may independently control the cameras a to d at a freely-selected time in such a way that the cameras a to d image.

Note that the traffic monitoring device 10 (20 or 30) may be a part of the police. In this case, the police (including the traffic monitoring device 10 (20 or 30)) is communicably connected to the traffic lights A to D and the cameras a to d via a wireless or wired network.

### Modification Example

In a modification example of the traffic monitoring system 1 (FIG. 1), the cameras a to d have an edge computing function, and when a vehicle approaches an intersection, the cameras a to d image the vehicle and automatically transmit time-series image data showing the vehicle to the traffic monitoring device 10 (20 or 30).

### First Example Embodiment

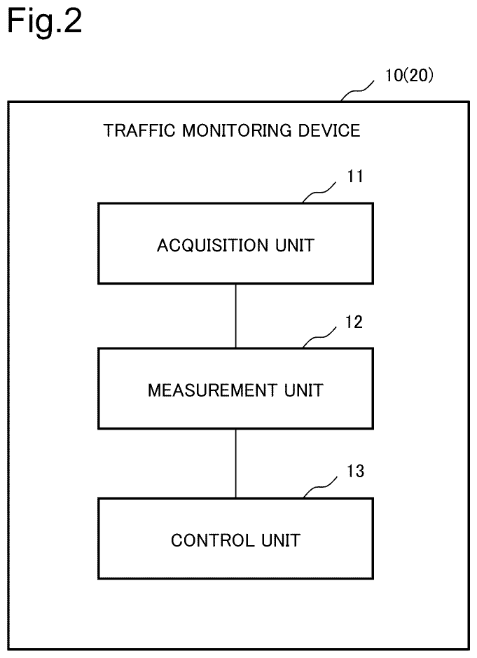

A first example embodiment will be described with reference to FIGS. 2 to 5. In the first example embodiment, a configuration in which a traffic light is controlled in such a way that a vehicle approaching an intersection can pass through the intersection without stopping before the intersection will be described.

### (Traffic Monitoring Device 10)

FIG. 2 is a block diagram illustrating a configuration of the traffic monitoring device 10 according to the first example embodiment. As illustrated in FIG. 2, the traffic monitoring device 10 includes an acquisition unit 11, a measurement unit 12, and a control unit 13.

The acquisition unit 11 acquires time-series image data showing a vehicle. The acquisition unit 11 is an example of an acquisition means.

In one example, the acquisition unit 11 acquires from the cameras a to d (FIG. 1) time-series image data imaged by the cameras a to d. The acquisition unit 11 selects time-series image data showing a vehicle approaching an intersection from time-series image data imaged by the cameras a to d using an image recognition technique. For example, the acquisition unit 11 selects time-series image data showing a vehicle approaching a position 30 meters before the intersection (or a line equivalent to the position) from the cameras a to d although the distance depends on the installation angle, the angle of view, the resolution, and the like of the cameras a to d.

For example, the acquisition unit 11 may detect an object having a feature of a vehicle from each piece of image data using a discriminator that has performed machine learning on a feature of a vehicle. Alternatively, the acquisition unit 11 may detect a vehicle from each piece of image data using an application programming interface (API) for object detection. The acquisition unit 11 extracts time-series image data in which a vehicle is detected (that is, time-series image data showing the vehicle) from time-series image data imaged by the cameras a to d. Alternatively, in a case where the cameras a to d have an edge computing function, the acquisition unit 11 can acquire only time-series image data showing a vehicle from the cameras a to d.

The acquisition unit 11 transmits the time-series image data showing the vehicle to the measurement unit 12.

The measurement unit 12 measures the speed of the vehicle using the time-series image data. The measurement unit 12 is an example of a measurement means.

In one example, the measurement unit 12 receives the time-series image data showing the vehicle from the acquisition unit 11. The measurement unit 12 measures the speed of the vehicle approaching the intersection based on the time interval of the time-series image data (the frame rate of the cameras a to d) and the change in the position of the vehicle in the time-series image data.

The measurement unit 12 outputs information indicating the measured speed of the vehicle to the control unit 13.

In a case where the speed of the vehicle is within a prescribed range, the control unit 13 controls a traffic light facing the vehicle in such a way that the traffic light shows a light color indicating permission to go forward. The control unit 13 is an example of a control means.

In one example, the control unit 13 receives, from the measurement unit 12, information indicating the speed of the vehicle measured by the measurement unit 12. The control unit 13 compares the speed of the vehicle with a prescribed range determined in advance. The prescribed range is, for example, from slightly more than zero to slightly more than the legal speed limit.

In a case where the speed of the vehicle is within the prescribed range, the control unit 13 sets a traffic light facing a vehicle traveling in a direction intersecting with the vehicle to a light color indicating prohibition to go forward (that is, a red light). Subsequently, the control unit 13 sets a traffic light facing the vehicle to a light color indicating permission to go forward (that is, a green light).

Alternatively, the control unit 13 may set the traffic light facing the vehicle to a light color indicating “go forward carefully” (a flashing yellow light).

### (Operation of Traffic Monitoring Device 10)

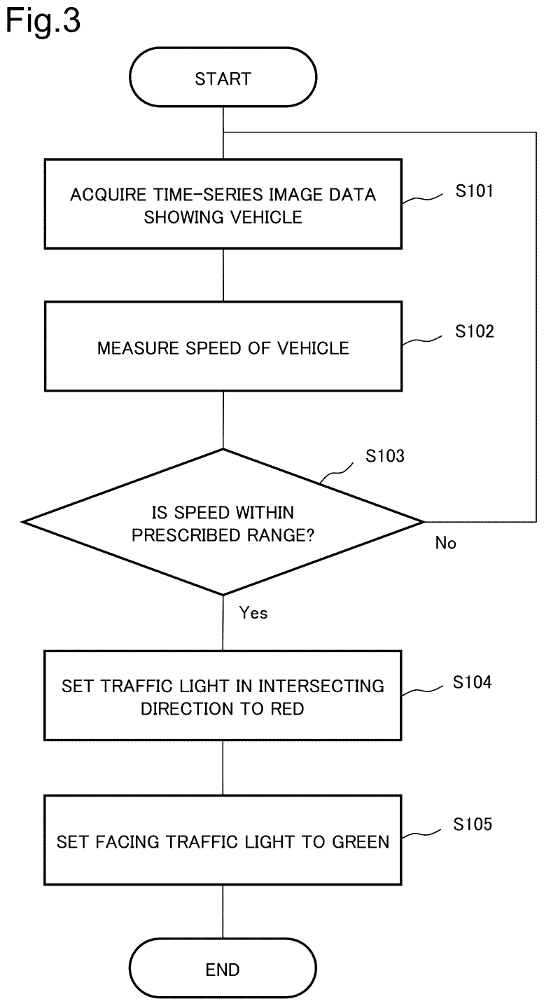

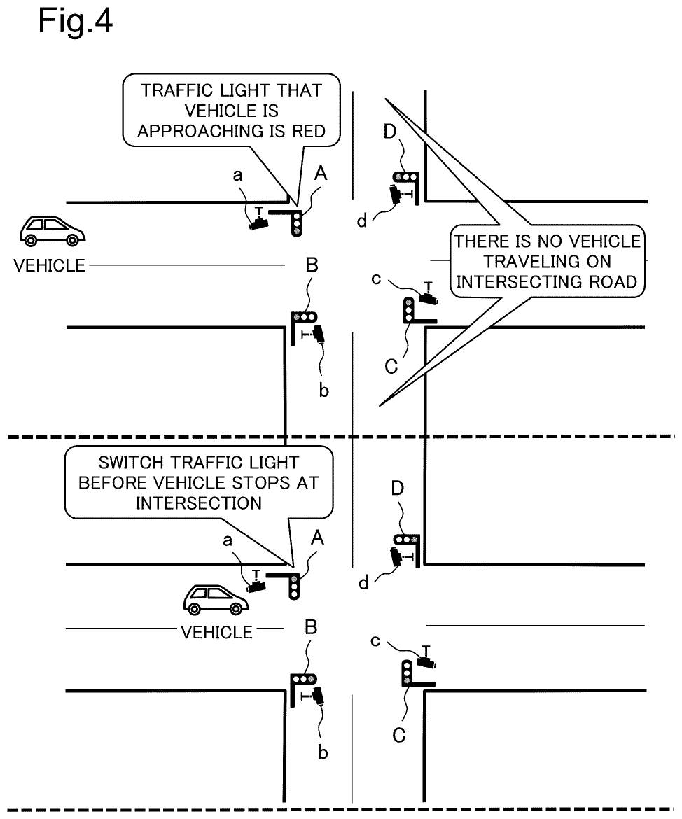

An operation of the traffic monitoring device 10 according to the first example embodiment will be described with reference to FIGS. 3 and 4. FIG. 3 is a flowchart illustrating a flow of processing executed by each of the units of the traffic monitoring device 10. FIG. 4 provides two views illustrating the movement of the vehicle and the change in the light colors of the traffic lights A to D along with the control of the traffic lights A to D executed by the traffic monitoring device 10.

As illustrated in FIG. 3, the acquisition unit 11 acquires time-series image data showing a vehicle approaching an intersection from the cameras a to d illustrated in FIG. 4 (S101). The acquisition unit 11 outputs the acquired time-series image data to the measurement unit 12. In FIG. 4, the vehicle is traveling from left to right and faces a pair consisting of the traffic light A and the camera a. Initially, the traffic lights A and C show the light color indicating prohibition to go forward (that is, the red light), and the traffic lights B and D show the light color indicating go forward (that is, the green light).

The measurement unit 12 measures the speed of the vehicle based on the change in the position of the vehicle in the time-series image data acquired from the camera a (S102). The measurement unit 12 outputs information indicating the measured speed of the vehicle to the control unit 13.

The control unit 13 determines whether the speed of the vehicle is within a prescribed range (S103). In a case where the speed of the vehicle is out of the prescribed range (No in S103), the flow returns to step S101. On the other hand, in a case where the speed of the vehicle is within the prescribed range (Yes in S103), the control unit 13 sets the traffic lights B and D facing a vehicle traveling in a direction intersecting with the vehicle to the light color indicating prohibition to go forward (red light) (S104).

Subsequently, the control unit 13 sets the traffic light A (and C) facing the vehicle to the light color indicating permission to go forward (green light) (S105).

This is the end of the operation of the traffic monitoring device 10 according to the first example embodiment.

### Modification Example

In one modification example, the condition under which the control unit 13 controls the traffic lights A to D is different from the condition that “the speed of the vehicle is within the prescribed range”.

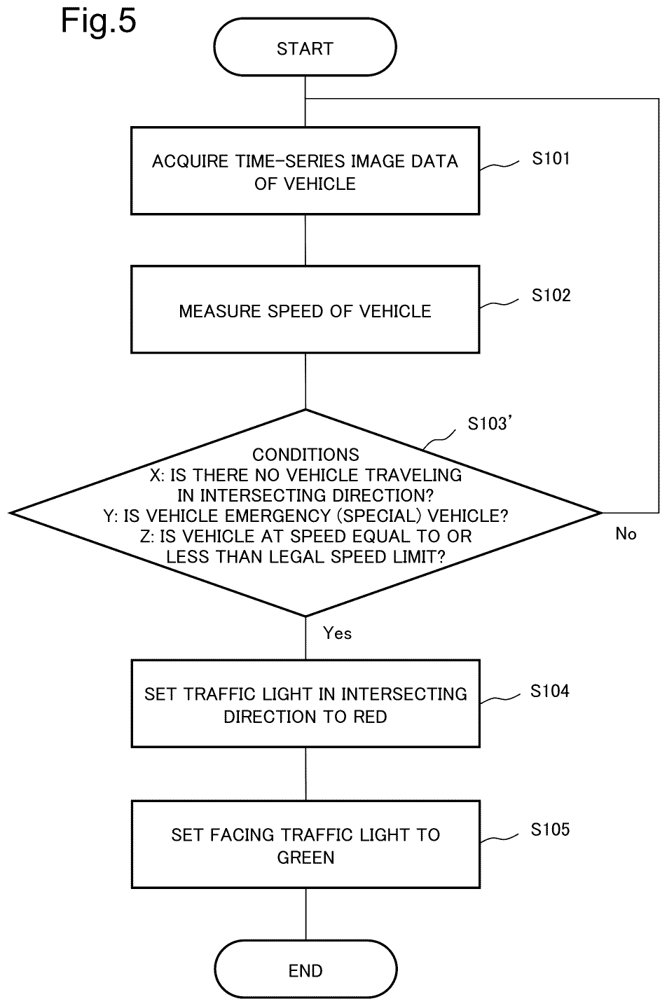

An operation of the traffic monitoring device 10 according to the modification example of the first example embodiment will be described with reference to FIG. 5. FIG. 5 is a flowchart illustrating a flow of processing executed by each of the units of the traffic monitoring device 10 according to the present modification example.

As illustrated in FIG. 5, the acquisition unit 11 acquires time-series image data showing a vehicle approaching an intersection from the cameras a to d illustrated in FIG. 4 (S101). The acquisition unit 11 outputs the acquired time-series image data to the measurement unit 12.

The measurement unit 12 measures the speed of the vehicle based on the change in the position of the vehicle in the time-series image data acquired from the camera a (S102). The measurement unit 12 outputs information indicating the measured speed of the vehicle to the control unit 13.

The control unit 13 determines whether the speed of the vehicle satisfies some or all of conditions X, Y, and Z described below (S103′). The combination of the conditions X, Y, and Z is not particularly limited.
Condition X: There is no other vehicle traveling in the direction intersecting with the vehicle.
Condition Y: The vehicle is an emergency (special) vehicle.
Condition Z: The vehicle is at equal to or less than the legal speed limit.

In a case where all of the conditions X, Y, and Z are not satisfied (No in S103′), the flow returns to step S101. On the other hand, in a case where some or all of the conditions X, Y, and Z are satisfied (Yes in S103′), the control unit 13 sets the traffic lights B and D facing a vehicle traveling in a direction intersecting with the vehicle to the light color indicating prohibition to go forward (red light) (S104).

Subsequently, the control unit 13 sets the traffic light A facing the vehicle to the light color indicating permission to go forward (green light) (S105).

This is the end of the operation of the traffic monitoring device 10 according to the modification example.

With the configuration according to the present modification example, it is possible to variously change the combination of the conditions X to Z for setting the traffic light facing the vehicle to the light color indicating permission to go forward.

### Effects of Present Example Embodiment

With the configuration according to the present example embodiment, the acquisition unit 11 acquires time-series image data showing a vehicle. The measurement unit 12 measures the speed of the vehicle using the time-series image data. In a case where the speed of the vehicle is within a prescribed range, the control unit 13 controls a traffic light facing the vehicle in such a way that the traffic light shows a light color indicating permission to go forward.

In particular, in a case where the speed of the vehicle is within the prescribed range, the control unit 13 sets a traffic light facing a vehicle traveling in a direction intersecting with the vehicle to a light color indicating prohibition to go forward, and then sets a traffic light facing the vehicle to a light color indicating permission to go forward.

The vehicle can pass through the intersection without stopping before the intersection. As a result, the number of times of braking is reduced, which leads to improvement in fuel efficiency and reduction in air pollution. In this manner, traffic can be made smoother by appropriately controlling traffic lights.

### Second Example Embodiment

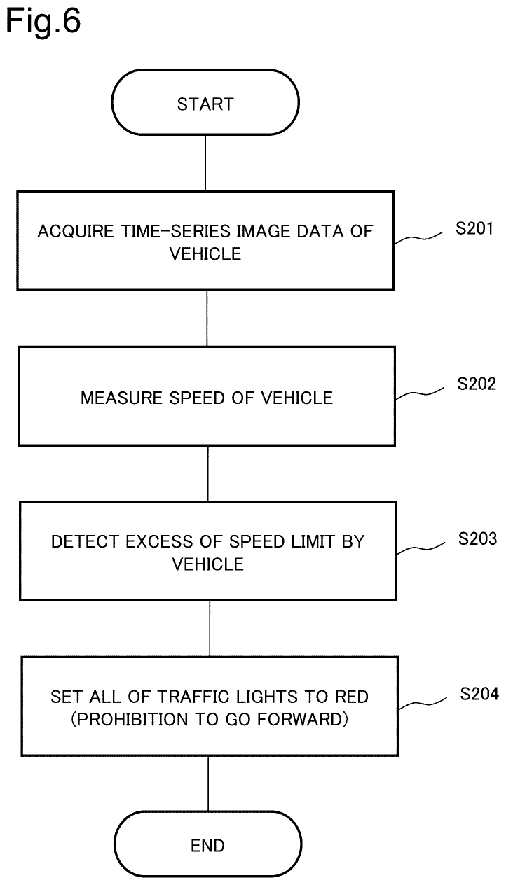

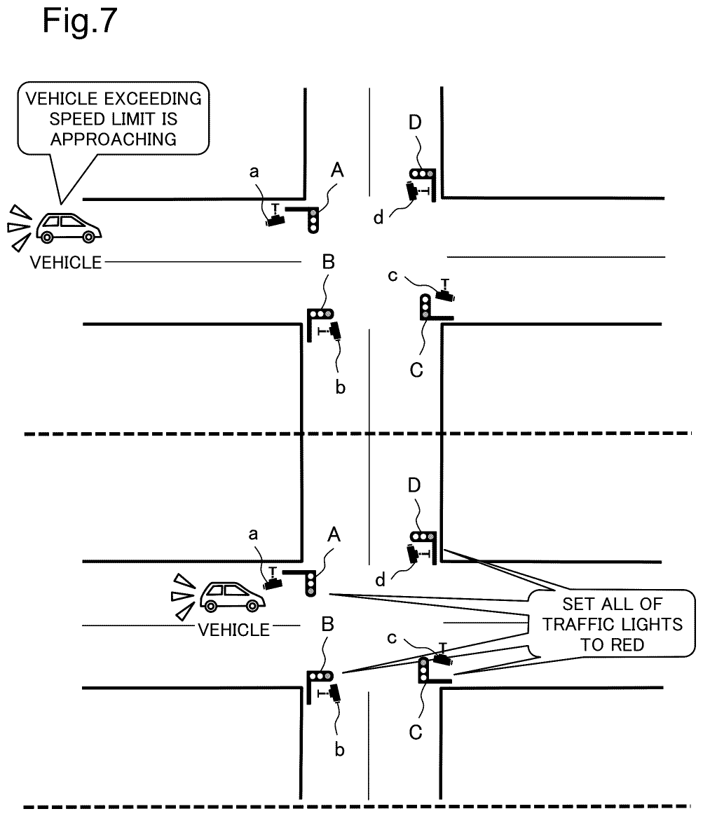

A second example embodiment will be described with reference to FIGS. 6 to 7. In the second example embodiment, a configuration in which a traffic light is controlled in such a way as to stop a vehicle exceeding a speed limit before an intersection will be described.

The configuration of the traffic monitoring device 20 according to the second example embodiment is the same as the configuration of the traffic monitoring device 10 (FIG. 2) according to the first example embodiment.

In the second example embodiment, the description of the common configuration to that of the first example embodiment will be omitted by citing the description of the first example embodiment.

### (Operation of Traffic Monitoring Device 20)

An operation of the traffic monitoring device 20 according to the second example embodiment will be described with reference to FIGS. 6 and 7. FIG. 6 is a flowchart illustrating a flow of processing executed by each of the units of the traffic monitoring device 20. FIG. 7 is a diagram illustrating a flow of control of the traffic lights A to D executed by the traffic monitoring device 20.

As illustrated in FIG. 6, the acquisition unit 11 acquires time-series image data showing a vehicle approaching an intersection from the cameras a to d illustrated in FIG. 7 (S201). The acquisition unit 11 outputs the acquired time-series image data to the measurement unit 12. In FIG. 6, the vehicle is traveling from left to right and faces a pair consisting of the traffic light A and the camera a.

The measurement unit 12 measures the speed of the vehicle based on the change in the position of the vehicle in the time-series image data acquired from the camera a (S202). The measurement unit 12 outputs information indicating the measured speed of the vehicle to the control unit 13.

The control unit 13 detects an excess of the speed limit by the vehicle (S203). Specifically, in a case where the speed of the vehicle measured by the measurement unit 12 exceeds a limit value, the control unit 13 determines that the vehicle exceeds the speed limit. In one example, the limit value is a value obtained by increasing the legal speed limit by 10%.

The control unit 13 sets all of the traffic lights A to D (FIG. 7) including the traffic lights B and D facing another vehicle traveling in a direction intersecting with the vehicle to the light color indicating prohibition to go forward (red light) (S204).

Subsequently, the control unit 13 may set only the traffic lights B and D facing the another vehicle traveling in the direction intersecting with the vehicle to the light color indicating permission to go forward (green light). As a result, it is possible to prevent the passage of the another vehicle traveling in the direction intersecting with the vehicle.

This is the end of the operation of the traffic monitoring device 20 according to the second example embodiment.

### Effects of Present Example Embodiment

With the configuration according to the present example embodiment, the acquisition unit 11 acquires time-series image data showing a vehicle. The measurement unit 12 measures the speed of the vehicle using the time-series image data. In a case where the speed of the vehicle is within a prescribed range, the control unit 13 controls a traffic light facing the vehicle in such a way that the traffic light shows a light color indicating permission to go forward.

The vehicle can pass through the intersection without stopping before the intersection. As a result, the number of times of braking is reduced, which leads to improvement in fuel efficiency and reduction in air pollution. In this manner, traffic can be made smoother by appropriately controlling traffic lights.

Further, with the configuration according to the present example embodiment, in a case where the speed of the vehicle exceeds the limit value, the control unit 13 sets all of the traffic lights to the light color indicating prohibition to go forward. The vehicle stops before the intersection, following the instruction of the traffic light. As a result, it is possible to suppress reckless running of the vehicle and achieve traffic safety. Also, the police can simplify a crackdown on a violation of a speed limit. Further, an effect of causing the user to voluntarily reduce the speed of the vehicle can also be expected.

### Third Example Embodiment

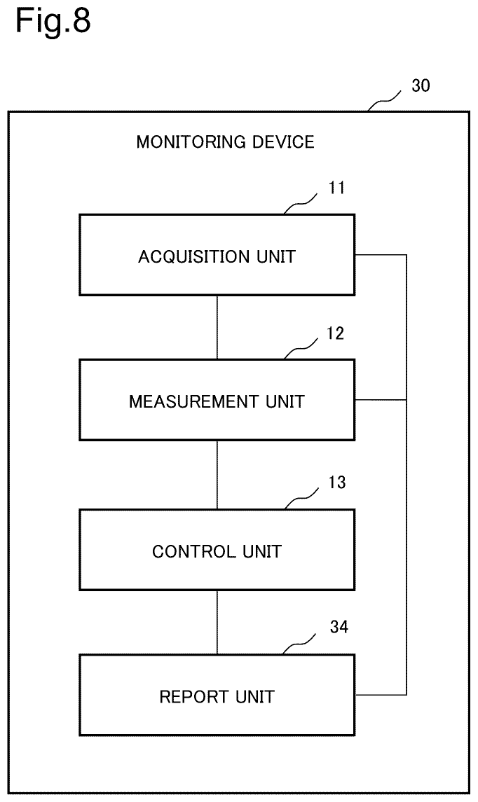

A third example embodiment will be described with reference to FIGS. 8 to 10. In the third example embodiment, a configuration in which, in a case where a vehicle exceeding the speed limit is detected, a violation of traffic law as well as identification information of the vehicle is reported to the police will be described.

In the third example embodiment, the description of the common configuration to that of the first or second example embodiment will be omitted by citing the description of the first or second example embodiment.

### (Traffic Monitoring Device 30)

FIG. 8 is a block diagram illustrating a configuration of the traffic monitoring device 30 according to the third example embodiment. As illustrated in FIG. 8, the traffic monitoring device 30 includes an acquisition unit 11, a measurement unit 12, and a control unit 13. The traffic monitoring device 30 further includes a report unit 34.

The report unit 34 reports a violation of traffic law by a vehicle to the police. The report unit 34 is an example of a report means.

In one example, in a case where the speed of a vehicle exceeds the limit value, the control unit 13 sets the traffic light facing the vehicle to the light color indicating prohibition to go forward. The control unit 13 notifies the report unit 34 that the traffic light facing the vehicle has been set to the light color indicating prohibition to go forward. The control unit 13 instructs the measurement unit 12 to re-measure the speed of the vehicle.

The measurement unit 12 determines whether the vehicle has stopped before the intersection by re-measuring the speed of the vehicle using the time-series image data. The measurement unit 12 notifies the report unit 34 of a determination result indicating whether the vehicle has stopped before the intersection.

The report unit 34 is notified by the control unit 13 that the traffic light facing the vehicle has been set to the light color indicating prohibition to go forward. Subsequently, the report unit 34 receives, from the measurement unit 12, the determination result indicating whether the vehicle has stopped before the intersection. In a case where the vehicle does not stop before the intersection, the report unit 34 reports ignoring of a traffic light by the vehicle to the police. For example, the report unit 34 transmits the report to the police via the network (FIG. 1).

In another example, the acquisition unit 11 further acquires identification information of the vehicle (for example, the car number of the vehicle). The acquisition unit 11 outputs the identification information of the vehicle to the report unit 34. The report unit 34 reports the violation of traffic law by the vehicle to the police and transmits, to the police, the identification information of the vehicle acquired.

### Operation of Traffic Monitoring Device 30; First Example

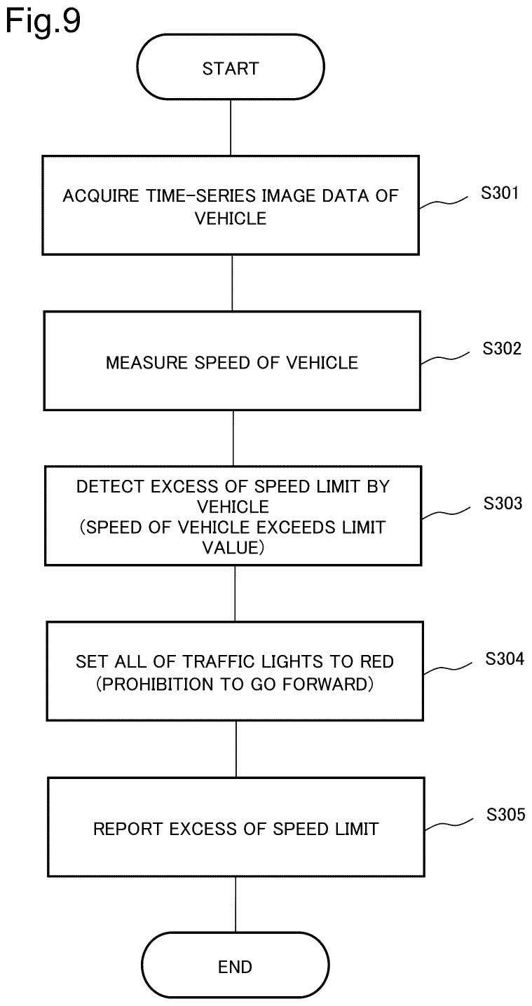

A first example of an operation of the traffic monitoring device 30 according to the third example embodiment will be described with reference to FIG. 9. FIG. 9 is a flowchart illustrating a flow of processing executed by each of the units of the traffic monitoring device 30.

As illustrated in FIG. 9, the acquisition unit 11 acquires time-series image data showing a vehicle approaching an intersection from the cameras a to d (FIG. 7) (S301). The acquisition unit 11 outputs the acquired time-series image data to the measurement unit 12.

The measurement unit 12 measures the speed of the vehicle based on the change in the position of the vehicle in the time-series image data acquired from the camera a (S302). The measurement unit 12 outputs information indicating the measured speed of the vehicle to the control unit 13.

The control unit 13 detects the excess of the speed limit by the vehicle (S303). Specifically, in a case where the speed of the vehicle measured by the measurement unit 12 exceeds a limit value, the control unit 13 determines that the vehicle exceeds the speed limit.

The control unit 13 sets all of the traffic lights A to D (FIG. 7) including the traffic lights B and D facing another vehicle traveling in a direction intersecting with the vehicle to the light color indicating prohibition to go forward (red light) (S304). Subsequently, the control unit 13 may set the traffic lights B and D to the light color indicating permission to go forward (green light).

The report unit 34 reports the violation of traffic law by the vehicle (here, the excess of the speed limit) to the police (S305). This is the end of the operation of the traffic monitoring device 30 according to the third example embodiment.

### Operation of Traffic Monitoring Device 30; Second Example

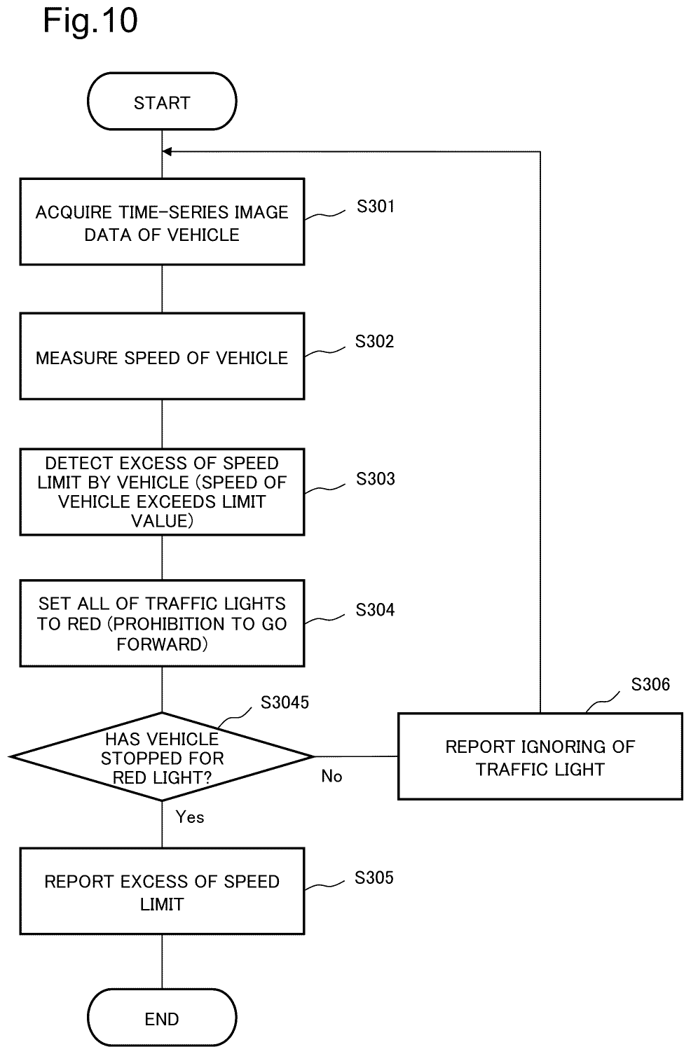

A second example of the operation of the traffic monitoring device 30 according to the third example embodiment will be described with reference to FIG. 10. FIG. 10 is a flowchart illustrating a flow of processing executed by each of the units of the traffic monitoring device 30.

As illustrated in FIG. 10, the acquisition unit 11 acquires time-series image data showing a vehicle approaching an intersection from the cameras a to d (FIG. 7) (S301). The acquisition unit 11 outputs the acquired time-series image data to the measurement unit 12.

The measurement unit 12 measures the speed of the vehicle based on the change in the position of the vehicle in the time-series image data acquired from the camera a (S302). The measurement unit 12 outputs information indicating the measured speed of the vehicle to the control unit 13.

The control unit 13 detects the excess of the speed limit by the vehicle (S303). Specifically, in a case where the speed of the vehicle measured by the measurement unit 12 exceeds a limit value, the control unit 13 determines that the vehicle exceeds the speed limit.

The control unit 13 sets all of the traffic lights A to D (FIG. 7) including the traffic lights B and D facing another vehicle traveling in a direction intersecting with the vehicle to the light color indicating prohibition to go forward (red light) (S304).

The report unit 34 determines whether the vehicle has stopped before the intersection, following the instruction of prohibition to go forward indicated by the light color of the traffic light A (S3045).

In a case where the vehicle does not stop before the intersection (No in S3045), the report unit 34 reports the ignoring of a traffic light and the excess of the speed limit by the vehicle to the police (S306). On the other hand, in a case where the vehicle stops before the intersection (Yes in S3045), the report unit 34 reports only the excess of the speed limit by the vehicle to the police (S305).

This is the end of the operation of the traffic monitoring device 30 according to the third example embodiment.

### Effects of Present Example Embodiment

With the configuration according to the present example embodiment, the acquisition unit 11 acquires time-series image data showing a vehicle. The measurement unit 12 measures the speed of the vehicle using the time-series image data. In a case where the speed of the vehicle is within a prescribed range, the control unit 13 controls a traffic light facing the vehicle in such a way that the traffic light shows a light color indicating permission to go forward.

The vehicle can pass through the intersection without stopping before the intersection. As a result, the number of times of braking is reduced, which leads to improvement in fuel efficiency and reduction in air pollution. In this manner, traffic can be made smoother by appropriately controlling traffic lights.

Furthermore, with the configuration according to the present example embodiment, the report unit 34 reports a violation of traffic law by the vehicle to the police. In particular, in a case where the speed of the vehicle exceeds a limit value, the report unit 34 reports the excess of the speed limit by the vehicle to the police.

Since the excess of the speed limit by the vehicle is reported to the police, the police can simplify a crackdown on a violation of a speed limit. Further, an effect of causing the user to voluntarily reduce the speed of the vehicle can also be expected.

### Other Examples

In the first to third example embodiments, the control of the traffic lights at the four-way intersection has been described. However, the control at the three-way or multi-way intersection can also be performed similarly to the case of the four-way intersection merely by changing the number of traffic lights and cameras.

### About Hardware Configuration

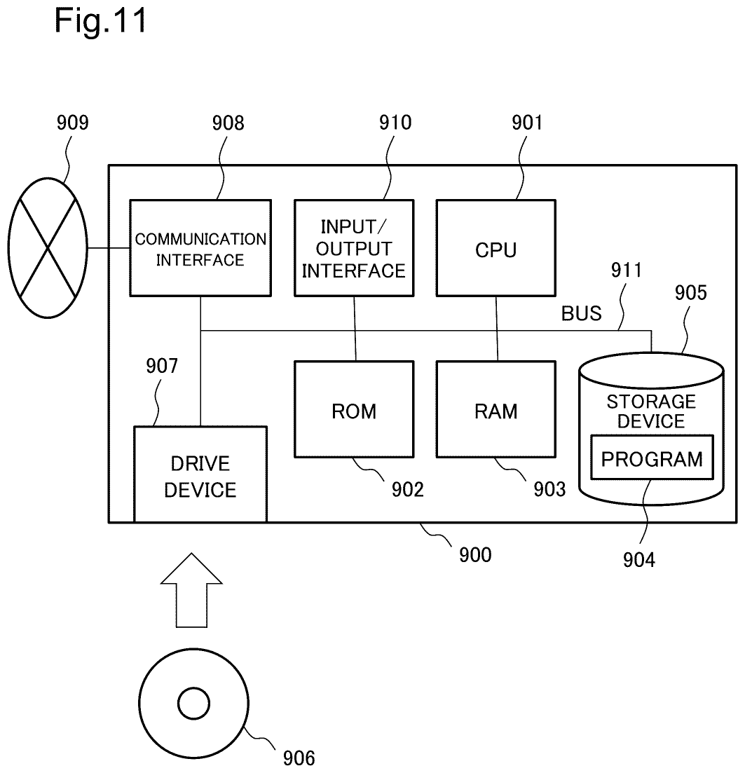

Each component of each of the traffic monitoring devices 10, 20, and 30 described in the first to third example embodiments represents a functional unit block. Some or all of these components are achieved by an information processing device 900 as illustrated in FIG. 11, for example. FIG. 11 is a block diagram illustrating an example of a hardware configuration of the information processing device 900.

As illustrated in FIG. 11, the information processing device 900 includes the following components as an example.
Central processing unit (CPU) 901
Read only memory (ROM) 902
Random access memory (RAM) 903
Program 904 loaded into RAM 903
Storage device 905 that stores program 904
Drive device 907 that reads from and writes in recording medium 906
Communication interface 908 connected to communication network 909
Input/output interface 910 that inputs and outputs data
Bus 911 that connects components

Each component of each of the traffic monitoring devices 10, 20, and 30 described in the first to third example embodiments is achieved by the CPU 901 reading and executing the program 904 that fulfills the function of the component. The program 904 that fulfills the function of each component is stored in the storage device 905 or the ROM 902 in advance, for example, and the CPU 901 loads the program into the RAM 903 and executes the program as necessary. The program 904 may be supplied to the CPU 901 via the communication network 909, or may be stored in the recording medium 906 in advance, read by the drive device 907, and supplied to the CPU 901.

With the above configuration, the traffic monitoring devices 10, 20, and 30 described in the first to third example embodiments are achieved as hardware. Therefore, similar effects to those described in the above example embodiments can be obtained.

### SUPPLEMENTARY NOTES

One aspect of the present invention is also described as the following supplementary notes, but is not limited to the following.

### Supplementary Note 1

A traffic monitoring device including
an acquisition means configured to acquire time-series image data showing a vehicle,
a measurement means configured to measure speed of the vehicle using the time-series image data, and
a control means configured to set a traffic light facing the vehicle to a light color indicating permission to go forward in a case where the speed of the vehicle is within a prescribed range.

### Supplementary Note 2

The traffic monitoring device according to supplementary note 1, wherein, in a case where the speed of the vehicle is within the prescribed range, the control means sets a traffic light facing an intersecting vehicle traveling in a direction intersecting with the vehicle to a light color indicating prohibition to go forward, and then sets the traffic light facing the vehicle to the light color indicating permission to go forward.

### Supplementary Note 3

The traffic monitoring device according to supplementary note 1 or 2, wherein, in a case where the speed of the vehicle exceeds a limit value, the control means sets both the traffic light facing the vehicle and the traffic light facing the intersecting vehicle traveling in a direction intersecting with the vehicle to a light color indicating prohibition to go forward.

### Supplementary Note 4

The traffic monitoring device according to any one of supplementary notes 1 to 3, further comprising a report means configured to report a violation of traffic law by the vehicle to police.

### Supplementary Note 5

The traffic monitoring device according to supplementary note 4, wherein, in a case where the speed of the vehicle exceeds the limit value, the report means reports an excess of a speed limit by the vehicle to the police.

### Supplementary Note 6

The traffic monitoring device according to supplementary note 4 or 5, wherein the control means sets the traffic light facing the vehicle to a light color indicating prohibition to go forward,
wherein the measurement means determines whether the vehicle has stopped before an intersection using the time-series image data, and
wherein, in a case where the vehicle does not stop before the intersection, the report means reports ignoring of a traffic light by the vehicle to the police.

### Supplementary Note 7

The traffic monitoring device according to any one of supplementary notes 4 to 6, wherein the acquisition means further acquires identification information of the vehicle, and
wherein the report means reports the violation of traffic law by the vehicle to the police and transmits, to the police, the identification information of the vehicle acquired.

### Supplementary Note 8

A traffic monitoring method including
acquiring time-series image data showing a vehicle,
measuring speed of the vehicle using the time-series image data, and
setting a traffic light facing the vehicle to a light color indicating permission to go forward in a case where the speed of the vehicle is within a prescribed range.

### Supplementary Note 9

A program that causes a computer to execute
acquiring time-series image data showing a vehicle,
measuring speed of the vehicle using the time-series image data, and
setting a traffic light facing the vehicle to a light color indicating permission to go forward in a case where the speed of the vehicle is within a prescribed range.

### Supplementary Note 10

A traffic monitoring system including
the traffic monitoring device according to any one of supplementary notes 1 to 7, and
a camera that images the vehicle.

### Supplementary Note 11

The traffic monitoring system according to supplementary note 10, wherein the camera analyzes time-series image data obtained by imaging a road, and transmits time-series image data, included in the time-series image data, showing a vehicle approaching an intersection to the traffic monitoring device.

### Supplementary Note 12

The traffic monitoring device according to any one of supplementary notes 1 to 7, wherein, in a case where the speed of the vehicle exceeds a limit value, the control means sets all of the traffic lights to the light color indicating prohibition to go forward, and then sets the traffic light facing the intersecting vehicle traveling in a direction intersecting with the vehicle to the light color indicating permission to go forward.

### Supplementary Note 13

The traffic monitoring device according to any one of supplementary notes 1 to 7, wherein, in a case where the speed of the vehicle exceeds a limit value, the control means sets the traffic light facing the vehicle to a light color indicating prohibition to go forward,
wherein the measurement means determines whether the vehicle has stopped before an intersection using the time-series image data, and
wherein, in a case where the vehicle stops before the intersection, the control means sets the traffic light facing the vehicle to the light color indicating permission to go forward.

### Supplementary Note 14

The traffic monitoring device according to any one of supplementary notes 1 to 7, wherein, in a case where the speed of the vehicle is within the prescribed range, the control means sets the traffic light facing the intersecting vehicle traveling in a direction intersecting with the vehicle to a light color indicating prohibition to go forward, and then sets the traffic light facing the vehicle to the light color indicating permission to go forward.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2021-056368, filed on Mar. 30, 2021, the disclosure of which is incorporated herein in its entirety by reference.

### INDUSTRIAL APPLICABILITY

The present invention can be used, for example, to make traffic and distribution smooth.

### REFERENCE SIGNS LIST

1 traffic monitoring system
10 traffic monitoring device
11 acquisition unit
12 measurement unit
13 control unit
20 traffic monitoring device
30 traffic monitoring device
34 report unit
A to D traffic light
a to d camera

What is claimed is:

1. A traffic monitoring device comprising:
a memory configured to store instructions; and
at least one processor configured to execute the instructions to perform:
acquiring time-series image data showing a vehicle;
measuring speed of the vehicle using the time-series image data; and
setting a traffic light facing the vehicle to a light color indicating permission to go forward in a case where the speed of the vehicle is within a prescribed range.

2. The traffic monitoring device according to claim 1, wherein
the at least one processor is configured to execute the instructions to perform:
in a case where the speed of the vehicle is within the prescribed range, setting a traffic light facing an intersecting vehicle traveling in a direction intersecting with the vehicle to a light color indicating prohibition to go forward, and then setting the traffic light facing the vehicle to the light color indicating permission to go forward.

3. The traffic monitoring device according to claim 1, wherein
the at least one processor is configured to execute the instructions to perform:
in a case where the speed of the vehicle exceeds a limit value, the control means setting both the traffic light facing the vehicle and the traffic light facing the intersecting vehicle traveling in a direction intersecting with the vehicle to a light color indicating prohibition to go forward.

4. The traffic monitoring device according to claim 1, wherein
the at least one processor is further configured to execute the instructions to perform:
reporting a violation of traffic law by the vehicle to police.

5. The traffic monitoring device according to claim 4, wherein
the at least one processor is configured to execute the instructions to perform:
in a case where the speed of the vehicle exceeds a limit value, reporting an excess of a speed limit by the vehicle to the police.

6. The traffic monitoring device according to claim 4, wherein
the at least one processor is configured to execute the instructions to perform:
setting the traffic light facing the vehicle to a light color indicating prohibition to go forward,
determining whether the vehicle has stopped before an intersection using the time-series image data, and
in a case where the vehicle does not stop before the intersection, reporting ignoring of a traffic light by the vehicle to the police.

7. The traffic monitoring device according to claim 4, wherein
the at least one processor is configured to execute the instructions to perform:
further acquiring identification information of the vehicle, and
reporting the violation of traffic law by the vehicle to the police and transmitting, to the police, the identification information of the vehicle acquired.

8. The traffic monitoring device according to claim 1, wherein
the at least one processor is configured to execute the instructions to perform:
in a case where the speed of the vehicle exceeds a limit value, setting all of the traffic lights to a light color indicating prohibition to go forward, and then setting the traffic light facing the intersecting vehicle traveling in a direction intersecting with the vehicle to the light color indicating permission to go forward.

9. The traffic monitoring device according to claim 1, wherein
the at least one processor is configured to execute the instructions to perform: in a case where the speed of the vehicle exceeds a limit value, setting the traffic light facing the vehicle to a light color indicating prohibition to go forward,
determining whether the vehicle has stopped before an intersection using the time-series image data, and
in a case where the vehicle stops before the intersection, setting the traffic light facing the vehicle to the light color indicating permission to go forward.

10. The traffic monitoring device according to claim 1, wherein
the at least one processor is configured to execute the instructions to perform:
in a case where the speed of the vehicle is within the prescribed range, setting the traffic light facing the intersecting vehicle traveling in a direction intersecting with the vehicle to a light color indicating prohibition to go forward, and then setting the traffic light facing the vehicle to the light color indicating permission to go forward.

11-12. (canceled)

13. A traffic monitoring method comprising:
acquiring time-series image data showing a vehicle;
measuring speed of the vehicle using the time-series image data; and
setting a traffic light facing the vehicle to a light color indicating permission to go forward in a case where the speed of the vehicle is within a prescribed range.

14. A non-transitory recording medium that stores a program that causes a computer to execute:
acquiring time-series image data showing a vehicle;
measuring speed of the vehicle using the time-series image data; and
setting a traffic light facing the vehicle to a light color indicating permission to go forward in a case where the speed of the vehicle is within a prescribed range.

15. The traffic monitoring method according to claim 13, wherein
in a case where the speed of the vehicle is within the prescribed range, setting a traffic light facing an intersecting vehicle traveling in a direction intersecting with the vehicle to a light color indicating prohibition to go forward, and then setting the traffic light facing the vehicle to the light color indicating permission to go forward.

16. The traffic monitoring method according to claim 13, wherein
in a case where the speed of the vehicle exceeds a limit value, the control means setting both the traffic light facing the vehicle and the traffic light facing the intersecting vehicle traveling in a direction intersecting with the vehicle to a light color indicating prohibition to go forward.

17. The traffic monitoring method according to claim 13, wherein reporting a violation of traffic law by the vehicle to police.

18. The non-transitory recording medium according to claim 14, wherein the program causes the computer to execute:
in a case where the speed of the vehicle is within the prescribed range, setting a traffic light facing an intersecting vehicle traveling in a direction intersecting with the vehicle to a light color indicating prohibition to go forward, and then setting the traffic light facing the vehicle to the light color indicating permission to go forward.

19. The non-transitory recording medium according to claim 14, wherein the program causes the computer to execute:
in a case where the speed of the vehicle exceeds a limit value, the control means setting both the traffic light facing the vehicle and the traffic light facing the intersecting vehicle traveling in a direction intersecting with the vehicle to a light color indicating prohibition to go forward.

20. The non-transitory recording medium according to claim 14, wherein the program causes the computer to execute:
reporting a violation of traffic law by the vehicle to police.
